(19) United States
(12) Patent Application Publication
(10) Pub. No.: US 2025/0222610 A1
(43) Pub. Date: Jul. 10, 2025

(54) Heavy Bag Halving Tool

(71) Applicant: Shon Johnson, Chugiak, AK (US)

(72) Inventor: Shon Johnson, Chugiak, AK (US)

(21) Appl. No.: 18/405,399

(22) Filed: Jan. 5, 2024

(51) Int. Cl. B26B 29/06

(52) U.S. Cl. CPC B26B 29/06

(57) ABSTRACT

The present invention is directed toward a portable construction, masonry, or landscaping tool used to assist in the halving of heavy, bagged, dry materials such as concrete or mortar. The bag splitting tool can be placed securely on any surface with the help of a non-slip footed base. The tool features a heavy-duty cutting bar with an elongated and recessed cutting channel that allow for the easy and safe splitting of most heavy bags used in construction.

### FIELD OF THE INVENTION

This invention pertains to a portable masonry and construction tool used to assist in cutting bags. More specifically it is designed to be a useful tool in the cutting or halving of heavy bags filled with materials such as concrete, mortar, or sand.

### BACKGROUND OF INVENTION

The cutting and/or halving of heavy bags on jobsites is a common practice in many industries such as construction, masonry, and landscaping. Cutting bags in half makes lifting and moving them much easier and can help prevent injury when carrying heavy dry materials such as concrete, mortar, or sand. Another important element to halving bags is portion control and customized mixing, as certain materials such as grout or concrete may need to be mixed in specific proportions. When workers need to carry materials to different parts of the construction site, weight distribution may be critical and cutting the bags in half may help to distribute the load more evenly.

Dry and bagged construction materials can sometimes weigh over 80 lbs. and opening these bags and pouring them into necessary containers or machines can be quite difficult and messy for workers. If precise measurements are needed on the jobsite, this makes it very difficult to pour accurate amounts required for the project out of the extremely heavy bags.

Not only are bagged materials found on jobsites but are also commonly needed for smaller and medium-sized jobs at residences. The weight of the dry and bagged materials could be quite difficult to manage for homeowners in poor health or unfit to handle working with such heavy weight. It would be quite beneficial to work with materials that are of at least half of their original weight.

What is needed is a heavy-duty tool that is designed to simplify the task of splitting heavy, bagged, dry materials in half.

### SUMMARY OF THE INVENTION

In accordance with the present invention, there is provided one embodiment, a heavy bag halving tool designed to assist in the halving of bags filled with heavy, dense, dry materials. The heavy bag halving tool has non-slip lifting handles and an elongated cutting channel with raised edges and aperture for safety and ease of cutting. The raised edges allow the user to quickly locate the channel and help keep the cutting tool from leaving the channel until the cut is completed.

The invention is directed toward a heavy bag halving tool comprising: an elongate cutting bar having a first end and a second end distal from said first end; a cutting channel disposed in a central portion of said cutting bar; a first lifting handle attached to said first end of said cutting bar; a second lifting handle attached to said second end of said cutting bar; and one or more footed bases disposed on a bottom side of said cutting bar.

In other embodiments the cutting channel further comprises one or more raised guards disposed at an edge of said cutting channel. In other embodiments each of said one or more footed bases further comprises one or more foot pads disposed on a bottom side of said footed bases. In other embodiments said first lifting handle and said second lifting handle are disposed at an angle from a longitudinal axis of said cutting bar.

In another embodiment the cutting channel comprises an aperture in said cutting bar. Optionally, the cutting channel comprises a depression in a top side of said cutting bar.

In another embodiment of the heavy bag halving tool, each of said one or more footed bases are removably connected to said cutting bar. Furthermore, at least one of said one or more footed bases may further comprise a male attachment component and said cutting bar further comprises a female attachment component configured to receive said male attachment component. In another embodiment, each of said one or more footed bases further comprises a telescopic extension support disposed between said footed base and said cutting bar.

The invention is also directed toward a method for cutting a bag containing construction material. The method comprises providing a heavy bag halving tool comprising an elongate cutting bar having a first end and a second end distal from said first end; a cutting channel disposed in a central portion of said cutting bar; a first lifting handle attached to said first end of said cutting bar; a second lifting handle attached to said second end of said cutting bar; and one or more footed bases disposed on a bottom side of said cutting bar; placing said bag across said heavy bag halving tool such that a back side of said bag is disposed against said cutting bar and a front side of said is in an upward facing position; cutting, with a cutting implement, a first cut along a center portion of said front side of said bag; lifting, via said first lifting handle and said second lifting handle, said cutting bar from a first position to a second position, wherein said second position is vertically higher than said first position; and cutting, with a cutting implement, a second cut along a center portion of said back side of said bag such that said bag is left in two completely separate disconnected portions.

Still other embodiments of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a perspective view of a heavy bag halving tool in accordance with an embodiment of the present invention;

FIG. 2 is a top view of a heavy bag halving tool in accordance with an embodiment of the present invention;

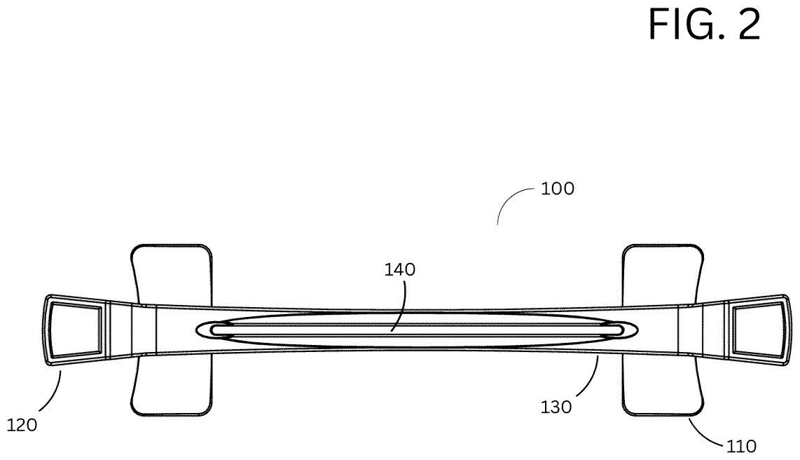

FIG. 3 is a side view of a heavy bag halving tool in accordance with an embodiment of the present invention;

FIG. 4 is an end view of a heavy bag halving tool in accordance with an embodiment of the present invention;

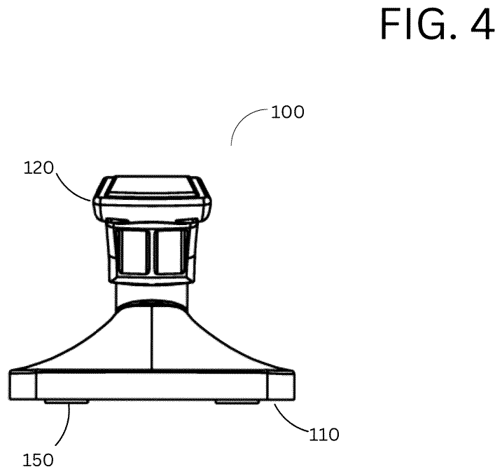

FIG. 5 is a bottom view of a heavy bag halving tool in accordance with an embodiment of the present invention; and

FIG. 6 is an exploded view of a heavy bag halving tool in accordance with an embodiment of the present invention.

### DETAILED DESCRIPTION OF THE PREFERRED EMBODIMENT

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

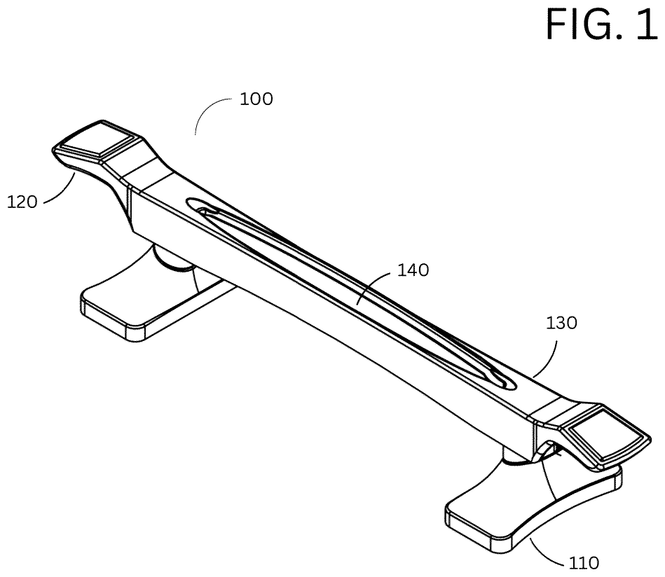

Referring to FIG. 1 is a heavy bag halving tool 100 comprising a cutting bar 130 with cutting channel 140 and lifting handles 120. The cutting bar 130 and lifting handles 120 may be made from materials such as aluminum, iron, steel, or any other metal. In other embodiments the cutting bar 130 and lifting handles 130 may also be made from polyvinyl chloride (PVC), ultra-high molecular weight (UHMW) polyethylene, hard nylon, polyurethane, or any other dense plastic material with high abrasion and wear resistance. The cutting bar 130 and lifting handles 120 may be of any length and width. The cutting bar 130 and lifting handles 120 may be made of a unitary body. In other embodiments the lifting handles 120 are removably secured to the cutting bar 130.

In other embodiments the cutting bar 130 is expandable to accommodate the halving of various sizes of bagged materials. In this embodiment the cutting bar 130 may detach at a center point where an additional sections of each side of the cutting bar 130 may be added to increase the length. In the preferred embodiment, the cutting bar 130 and lifting handles 120 may have a combined length greater than 14″ as designed to hold the common width of most bagged, dry materials, although the combined length can be of any length.

In other embodiments the cutting bar 130 may be hinged at the horizontal center allowing for the bar to be folded horizontal or vertical for compact storage. The hinge may be one of a butt-hinge, concealed hinge, piano hinge, or any other hinge.

The cutting channel 140 is designed to guide the user's preferred cutting or slicing tool, such as a box cutter with razor blade and allows the cutting tool to pass through the channel to the cutting surface inner portion of the bag. The cutting channel 140 may be any size and shape. In the preferred embodiment the cutting channel 140 is an elongated aperture in the cutting bar 130. In other embodiments the cutting channel is a simple depression in the cutting bar 130.

In the preferred embodiment, the heavy bag is placed atop the heavy bag halving tool 100 and sliced at its center. The lifting handles 120 are lifted vertically forming two bag halves that are still connected by an inner bag portion. The bag halves can be then be separated by a user by cutting the bag through the cutting channel 140 with any preferred cutting tool.

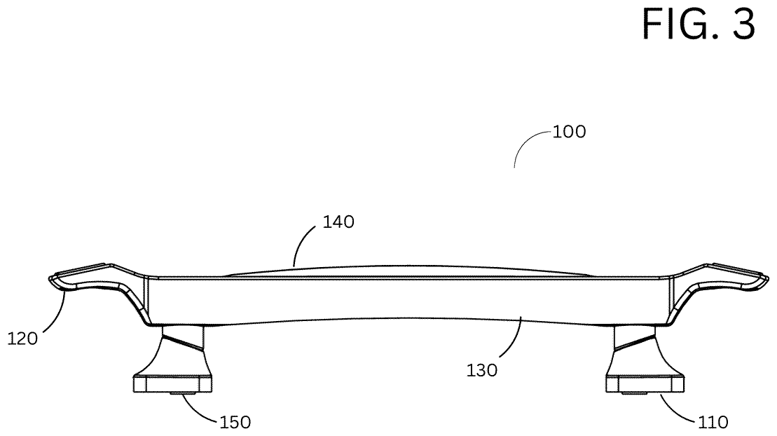

Now referring to FIG. 3, the lifting handles 120 are configured at any angle with a distinctive angular orientation away from the cutting bar 130 at each end of the heavy bag cutting tool 100. The lifting handles 120 are designed with any upper and downward angle enabling a secure grip and balanced lifting and may include non-slip features such as grip pads, rubberized or traction coatings, or textured surfaces. The lifting handles 120 may or may not be detachable and may comprise a grip portion and an attachment, wherein the attachment portion may be affixed to the cutting bar 130. In other embodiments the lifting handles 120 may be folded vertically or horizontally for storage by a butt-hinge, concealed hinge, piano hinge, or any other hinge.

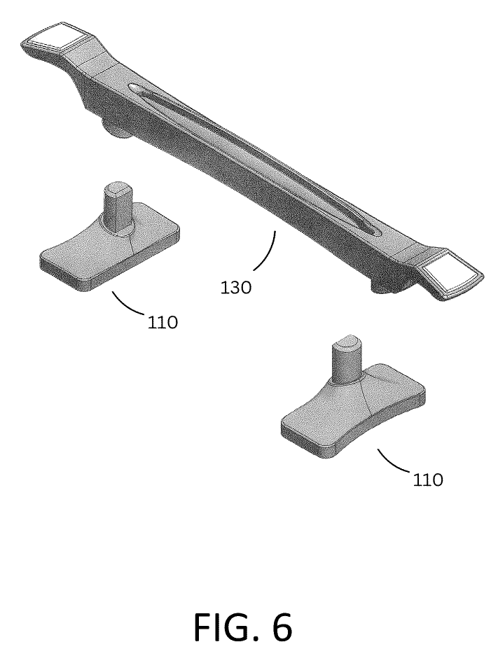

The footed base 110 is designed to allow the heavy bag halving tool 100 to rest securely on any surface and may or may not be detachable from the cutting bar 130. The footed base 110 may be made from materials such as aluminum, iron, steel, or any other metal and may also be made from PVC, UHMW polyethylene, hard nylon, polyurethane, or any other plastic material. The footed base 110 may be of any number and size or shape and may be interchangeable with any footed bases 110 of any other shape size dependent on the various surfaces a user may encounter. The footed base 110 may also have an adjustable height telescopic feature, allowing for the height of the cutting bar 130 to increase or decrease from the surface placed upon. In the preferred embodiment, as illustrated in FIG. 6, there are two sections of the footed base 110 removably secured to opposite ends of the cutting bar 130. The two sections of the footed base 110 may connect with the cutting bar 130 in any manner. Each footed base 110 may have a male attachment that fits into a female counterpart on the cutting bar 130. In other embodiments the footed base 130 may have a female counterpart to a male component on the cutting bar 130. The footed base 110 may have a friction fit with the cutting bar 130. In another embodiment there may be a locking mechanism to keep the footed base 110 connected to the cutting bar 130.

Referring to FIG. 3, the cutting channel 140 may have a gradually elevated raised edge along the outer perimeter of the major axis, wherein said raised edge is designed as a safety guided blade guard to keep the user's cutting tool engaged only within the cutting channel 140 until the bag cut is completed and the cutting tool exits the channel. Once lifted, the raised edges may also help the user see the cutting channel 140 under the bag layer more easily.

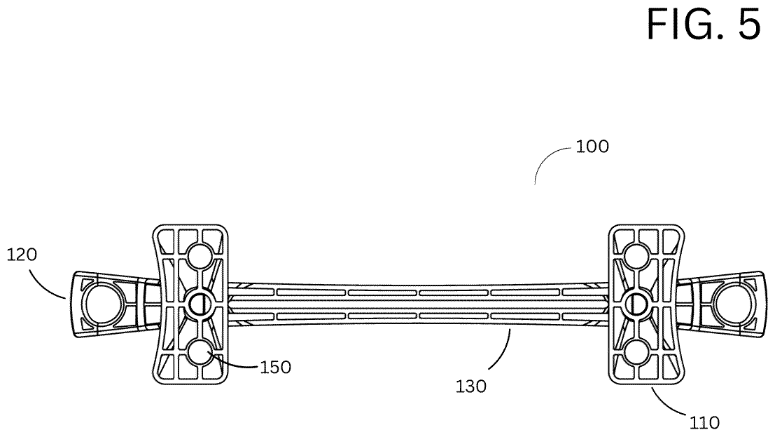

Referring to FIG. 5, the footed base 110 may have any number of foot pads 150 designed with non-slip features such as grip pads, rubberized or traction coatings, textured surfaces, or any other grip material and be made of any size or shape. In other embodiments, the footed bases 110 may be interchangeable and the foot pads 150 vary depending on varying footed bases 110. For instance, one set of footed bases 110 may be rectangular in shape and another version of the footed bases 110 may be triangular in shape. In another embodiment, one set of footed bases 110 that are short relative to the ground may be used for the first cut of the bag. The user may then lift the cutting bar 130 with the bag and place the cutting bar on a second set of footed bases 110 that are higher relative to the ground to complete the second cut.

The heavy bag halving tool may have any other combination of elements or components added on without diverting from the scope of the invention. In one embodiment, there may be a cutting blade attached within the cutting channel 140 to a handle on the exterior of the cutting bar 130 pointed upward. As the user slides the handle from one end of the cutting bar 130 to the other, a cut is made to separate the bag in half. In other embodiments, there may be LED lights connected to the lifting handles 120 that permit the heavy bag halving tool 100 to be used at night.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A heavy bag halving tool comprising:
a) an elongate cutting bar having a first end and a second end distal from said first end;
b) a cutting channel disposed in a central portion of said cutting bar;
c) a first lifting handle attached to said first end of said cutting bar;
d) a second lifting handle attached to said second end of said cutting bar; and
e) one or more footed bases disposed on a bottom side of said cutting bar.

2. The heavy bag halving tool as in claim 1 wherein said cutting channel further comprises one or more raised guards disposed at an edge of said cutting channel.

3. The heavy bag halving tool as in claim 1 wherein each of said one or more footed bases further comprises one or more foot pads disposed on a bottom side of said footed bases.

4. The heavy bag halving tool as in claim 1 wherein said first lifting handle is disposed at an angle from a longitudinal axis of said cutting bar; and wherein said second lifting handle is disposed at an angle from said longitudinal axis of said cutting bar.

5. The heavy bag halving tool as in claim 1 wherein said cutting channel comprises an aperture in said cutting bar.

6. The heavy bag halving tool wherein said cutting channel comprises a depression in a top side of said cutting bar.

7. The heavy bag halving tool as in claim 1 wherein each of said one or more footed bases are removably connected to said cutting bar.

8. The heavy bag halving tool as in claim 7
a) wherein at least one of said one or more footed bases further comprises a male attachment component;
b) wherein said cutting bar further comprises a female attachment component configured to receive said male attachment component.

9. The heavy bag halving tool as in claim 8 wherein each of said one or more footed bases further comprises one or more foot pads disposed on a bottom side of said footed bases.

10. The heavy bag halving tool as in claim 9 wherein said cutting channel comprises an aperture in said cutting bar.

11. The heavy bag halving tool as in claim 10 wherein said cutting channel further comprises one or more raised guards disposed at an edge of said cutting channel.

12. The heavy bag halving tool as in claim 11 wherein said first lifting handle is disposed at an angle from a longitudinal axis of said cutting bar; and wherein said second lifting handle is disposed at an angle from said longitudinal axis of said cutting bar.

13. The heavy bag halving tool as in claim 1 wherein each of said one or more footed bases further comprises a telescopic extension support disposed between said footed base and said cutting bar.

14. A method for cutting a bag containing construction material comprising
a) providing a heavy bag halving tool, said heavy bag halving tool comprising
1) an elongate cutting bar having a first end and a second end distal from said first end;
2) a cutting channel disposed in a central portion of said cutting bar;
3) a first lifting handle attached to said first end of said cutting bar;
4) a second lifting handle attached to said second end of said cutting bar; and
5) one or more footed bases disposed on a bottom side of said cutting bar;
b) placing said bag across said heavy bag halving tool such that a back side of said bag is disposed against said cutting bar and a front side of said is in an upward facing position;
c) cutting, with a cutting implement, a first cut along a center portion of said front side of said bag;
d) lifting, via said first lifting handle and said second lifting handle, said cutting bar from a first position to a second position, wherein said second position is vertically higher than said first position; and
e) cutting, with a cutting implement, a second cut along a center portion of said back side of said bag such that said bag is left in two completely separate disconnected portions.
